(19) United States
(12) Patent Application Publication
(10) Pub. No.: US 2006/0206608 A1
(43) Pub. Date: Sep. 14, 2006

(54) User terminal management apparatus, user terminal management program, and user terminal management system

(75) Inventors: Kaname Naito, Tokyo (JP); Eiichi Kondoh, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/368,670

(22) Filed: Mar. 7, 2006

(30) Foreign Application Priority Data
Mar. 11, 2005 (JP) 2005-068389

(51) Int. Cl. G06F 15/173

(52) U.S. Cl. 709/224

(57) ABSTRACT

An apparatus, program, and system that manages user terminal in an integrated fashion is disclosed. User terminal management apparatus 20, for managing the plurality of user terminal group 10a-10n, comprised of information tables 203b, 204b for storing prescribed user terminal information for each terminal in user terminal group 10, interface controller 201 for receiving user terminal information transmitted from user terminal group 10, data analyzer 202 for detecting whether prescribed information is included in the user terminal information received via interface controller 201, IPv6 address information controller 203a, FW configuration information manager 204a, and DDNS controller 205 for performing registration/update/transmission of IP addresses and firewall configuration information based on user terminal information detected by data analyzer 202 and user terminal information stored in the information tables.

### FIELD OF THE INVENTION

The present invention would preferably be applied to an IPv6 network system provided with a DNS server and a database.

The present invention relates to a user terminal management apparatus that unitively manages the user terminal information and security information configured in each of the user terminals through an IP network. And the present invention relates particularly to the user terminal management apparatus, program, and system that manage the IP addresses of each of the user terminals in an integrated fashion, when some IP addresses are assigned to a user terminal and the IP addresses are changed arbitrary. In addition, they manage the security policies that are set in each of the user terminals in an integrated fashion. So, they can alarm user terminals immediately when security holes, etc., are found.

### DESCRIPTION OF THE RELATED ART

In a general system environment, one user terminal has one LAN interface, thus, it has only been possible to assign one IPv4 address to one LAN interface in IPv4 system.

For this reason, user terminals correspond on a one-to-one basis with IPv4 addresses; therefore, it was easy to associate user terminals with IP addresses in order to manage them. And then, tracking of users from various logs (containing IPv4 addresses) became possible.

However, in the system of IPv6, which assign a plurality of IP addresses to one LAN interface, it is possible for a user terminal to have a plurality of IP addresses.

Additionally, an anonymous address is defined in RFC3041, thus, user terminals can change IPv6 addresses by generating the low 64 bits of their IPv6 addresses by using random numbers, and regenerating them at predetermined time intervals.

For this reason, it has been a problem for network administrators that they were not able to manage terminals using a plurality of IPv6 addresses that were established in user terminals or anonymous addresses.

Additionally, it is envisaged that peer-to-peer communication increases with IPv6, and it is desirable for each user terminal to install a personal firewall for security. However, in such cases, the security policies of personal firewalls installed in each user terminal cannot be managed in an integrated fashion.

To solve such problems, for example, Japanese Patent Laid-Open No. 242142/2004 (FIG. 2, pages 1 to 5) suggests a management method in which a user's terminal apparatus sends a router solicitation (RS) when the user logs in to the network, and the user's authentication server performs integrated management of IPv6 addresses; a combination of the interface ID included in the RS and the prefix data issued by the provider edge router.

Additionally, with respect to the uniform management of security information, for example, Japanese Patent Laid-Open No. 261788/2002 (FIG. 1, pages 1 to 4) suggests a firewall management system that generates and manages all firewall configuration information to communicate with another LAN system conforming to the operational policies.

In the management method described in Japanese Patent Laid-Open No. 242142/2004, it is difficult for an IPv6 network to respond to cases in which the IP address of a user terminal is frequently changed after network login, such as newly-adopted anonymous addresses. And it has been impossible for the network administrator to grasp and manage a plurality of IPv6 addresses, including anonymous addresses, in real time.

Additionally, in the firewall management system described in Japanese Patent Laid-Open No. 261788/2002, although communication regulations among LANs or terminal groups are manageable, management of firewalls on a terminal basis cannot be performed. In an IPv6 network, security holes may be caused by each users configuring of a firewall for their own terminal, and the management system described in Japanese Patent Laid-Open No. 261788/2002 cannot perform integrated management of personal firewalls installed in each user terminal.

### SUMMARY OF THE INVENTION

The present invention is suggested in order to settle the above-mentioned problems in prior art. In order to provide a user terminal management apparatus, user terminal management program, and user terminal management system wherein IP addresses of each user terminals can be managed in an integrated manner in the case that a plurality of IP addresses are established in a user terminal and the established IP addresses are arbitrarily changed, and security policies established in each user terminal can be managed in an integrated manner, so as to notify user terminals immediately in the case that security holes, etc., are found.

In order to achieve the abovementioned objective, the user terminal management system in the present invention is a user terminal management apparatus that manages user terminals, wherein the user terminal information about said user terminals is configurable or changeable, the user terminal apparatus comprising an information table which stores the user terminal information of each of the user terminals, a data analyzer which detects whether said user terminal information is included in the user terminal information, a data controller which executes said processing including at least one for registration, updates, or transmission of user terminal information, based on said user terminal information detected in said data controller and said user information stored in said information table.

In accordance with the user terminal management apparatus of the present invention having such a structure, the user terminal information is transmitted to the user terminal management apparatus at arbitrary times.

Subsequently, in the user terminal management apparatus, prescribed processing, including registration, updates, and transmission to other apparatus is executed based on the user terminal information registered and stored in the table and user terminal information transmitted from user terminals.

This enables the user terminal management apparatus to grasp user terminal information that is arbitrarily established or changed in each user terminal in real time and to manage the information in an integrated manner.

In this process, transmission of user terminal information from user terminals, for example, can be arranged so as to be performed each time user terminal information is changed in each user terminal.

This enables the user terminal management apparatus to grasp and manage the latest configuration data and user terminal information in real time while minimizing the frequency of data transmission to the terminal management apparatus, enabling construction of a user terminal management system which is concerning the present invention through a simple configuration, without increasing load on the network.

More specifically, a structure is provided in which the user terminal information includes an IP address of the user terminal.

Additionally, the controller determines the necessity for registration of said IP address information in the DNS server and transmits said IP address information to the DNS server, according to the determination results, when said IP address information is detected by said data controller.

Further, the data analyzer detects whether said IP address is included in said user terminal information received from one of the user terminals, and said controller registers or updates said IP address as user terminal information stored in said information table when said IP address is detected by said data controller.

In accordance with the user terminal management apparatus of the present invention having such a structure, in the case that an IP address established in a user terminal is changed, notification of the information of the changed IP address is given and transmitted to the user terminal management apparatus by the relevant user terminal.

Subsequently, the user terminal management apparatus registers or updates the new IP address information in the user terminal information storage table, based on the IP address information received.

This enables the user terminal management apparatus to update and manage the plurality of IP address information on an as-needed basis, and integrated management of user terminals, in the case of, for example, where a plurality of IP addresses, including anonymous addresses, are dynamically established and used in an IPv6 (Internet Protocol Version 6) network.

Additionally, saving logs of IP address changes, etc., make it possible to identify user terminals in the case that there is unauthorized access by any of the user terminals; therefore, it serves as an effective security measure.

At this point, a case in which a plurality of addresses are assigned to one user terminal (Multi Prefix) to realize the multi-home function, may be cited as an example of a case in which a plurality of IPv6 addresses are established in one user terminal.

The multi-home function is a function to enhance fault tolerance by maintaining connectivity through connection with a plurality of (for example, 2) ISPs, in order that, in the case of a fault occurring in one of the ISP lines, another ISP can be used.

The user terminal management apparatus of the present invention enables integrated management of configuration information of a plurality of user terminals, including user terminals in which the abovementioned multi-home function are established.

Furthermore, the user terminal management apparatus is adapted to determine the necessity of registration of relevant IP addresses in the DNS server upon receiving information regarding changed IP addresses from user terminals and to notify the DNS server of the IP addresses according to judgment results.

In a DDNS (Dynamic Domain Name System) server, a correspondence table between IPv6 addresses and domain names (FQDN: Fully Qualified Domain Name) can be updated upon receiving notice from the user terminal management apparatus.

This structure enables to obtain the IP address currently being used by the counterpart terminal (user terminal on the other side), by sending the DSN server an address resolution request for the FQDN address of the counterpart terminal it desires to communicate with from each user terminal, and then, stable communication is realized.

At this point, necessity for registration in the DNS server is determined based on user terminal information. Information managed by the user terminal management apparatus includes “information showing whether registration in the DNS server is necessary” for each host name, and the user terminal management apparatus refers to this information when judging the necessity of registration processing in the DNS server.

Judgments on necessity for registration in the DNS server are made based on the following reasons: for example, it is desirable to keep a user terminal private, or correspondence between IPv6 and the FQDN is already established, in other words, there is no need for dynamic registration in the DNS server such as in the case of terminals for server use, whereas there are cases in which host names of domain names need to be made public as public servers or peer-to-peer communication terminals.

Meanwhile, notification to and registration in the DNS server can be performed based on the DNS update defined in the RFC2136, and a general-purpose server that complies with the definition can be used as the DNS server; therefore, easy and inexpensive establishment of a system is possible, since there is no need for preparing a special server, etc.

Further, the data analyzer detects whether firewall configuration information is included in the user terminal information received from one of the user terminals, and when said firewall configuration information is detected by said data analyzer, said controller compares detected said firewall configuration information to said user terminal information stored in said information table, extracts the differences, and transmits said differences to said user terminals.

In accordance with the user terminal management apparatus of the present invention comprised as described above, in the case that the firewall information established in a user terminal is changed, the relevant user terminal sends a notification and transmit the changed firewall information to the user terminal management apparatus.

Subsequently, the user terminal management apparatus compares the received firewall information with the standard security policy stored in the table (basic profile) and extracts differences, if there are any, and notifies the difference information to the user terminal.

In accordance with this structure, the user terminal management apparatus has the ability to perform integrated management of configuration data of the firewall currently established in each user terminal, and, in the case that the firewall configuration data in each user terminal is not in accordance with the standard security policy, it has the ability to give notification of the contents and prompt to change a firewall data configuration.

Therefore, this structure allows the user terminal management apparatus to grasp and manage the security information established or changed in each unit basis in an integrated manner, enabling effective network operation and management.

Meanwhile, transmission of firewall configuration information to the user terminal management apparatus can be executed at arbitrary times established on the user terminal side.

The timing can be freely configured, such as at the start-up of user terminals, at a constant cycle, or at times of firewall configuration data changes, for instance.

This enables flexible security management according to the user of each application, network configuration or security policies, etc., providing a user terminal management system superior in versatility and extensibility.

Additionally, the present invention, as described above, can be provided as a user terminal management program or user terminal management system, as well as a user terminal management apparatus.

More specifically, the user terminal management program of the present invention shows a user terminal management program which comprises the user terminal apparatus for managing one or more user terminals, wherein said user terminal information, including IP address, can be arbitrarily configured or changed, to function as: a program to store user terminal information as information tables for each of the user terminals, a program which receives user terminal information to be transmitted from user terminals, a program which detects whether or not prescribed user information is included in the received user terminal information and a program which executes prescribed processing including at least one for registration, updates, or transmission of user terminal information, based on user terminal information detected and user information stored as an information table.

As described above, the user terminal management apparatus comprising the present invention can be realized by installing the program in information technology equipment such as server equipment, workstations, or personal computers. Also, each user terminal can be realized by installing the program in various IPv6-capable terminals, such as personal computers, PDAs, or cell-phone units.

This enables the provision of a user terminal management system superior in versatility and extensibility.

Furthermore, a user terminal management system comprises one or more user terminals wherein prescribed user terminal information is arbitrarily configurable or changeable, further comprising: a user terminal management apparatus for managing user terminal information of said user terminals, wherein said user terminals comprise the means for transmitting updated user terminal information to said terminal management apparatus in the case that the user terminal information configured in the relevant user terminal is changed and said user terminal management apparatus comprising an information table for storing the user terminal information of each of the user terminals, an interface controller for receiving user terminal information transmitted from user terminals, a data analyzer for detecting whether prescribed user information is included in user terminal information received through said interface controller and a controller for executing prescribed processing including at least one for registration, updates, or transmission of user terminal information, based on user terminal information detected in said data analyzer and user terminal information stored in said information table.

In accordance with this invention, in the case that a plurality of IP addresses are established in a user terminal and the established IP addresses are arbitrarily changed, the user terminal management apparatus can manage the IP addresses of each of the user terminal in an integrated manner.

Furthermore, the user terminal management apparatus can carry out an integrated management security policy for the firewall established in each of the user terminal and, in the case that a security hole, etc., is found, immediately inform the user terminal.

### BRIEF DESCRIPTION OF THE DRAWINGS

FIG. 1 shows an overview of the management of configuration data relating to one embodiment of the present invention.

FIG. 2 shows a schematic diagram illustrating the main flow of firewall configuration information established in the user terminals of the user terminal management system of the present invention.

FIG. 3 is a block diagram illustrating a more specific structure of the user terminal management system of the present invention.

FIG. 4 is a flow chart illustrating an embodiment of the process of the present invention.

FIGS. 5 and 6 are flow charts of further steps in the process of FIG. 4.

FIG. 7 illustrates a specific example of user terminal information data managed in an embodiment of the user terminal management system of the present invention.

### DETAILED DESCRIPTION OF THE PREFERRED EMBODIMENTS

The preferable embodiment of the user terminal management apparatus and user terminal management system of the present invention is explained hereinafter, with reference to the drawings.

At this point, the user terminal management apparatus and user terminal management system in the present invention are realized through the processing, means, and functions executed by orders of the program (software). The program sends orders to each component of the computer to make them perform prescribed processing and functions as described hereinafter; namely, various processing and means in the user terminal management system of the present embodiment are realized by specific means in which a program and a computer collaborate.

Meanwhile, all or part of the program is provided, for instance, by using recording media readable by random computers, such as magnetic discs, optical discs, semiconductor memory, or other media, and the program readout of the media is installed in the computer and executed. Additionally, the program can also be directly downloaded to the computer and executed via communication lines without using media.

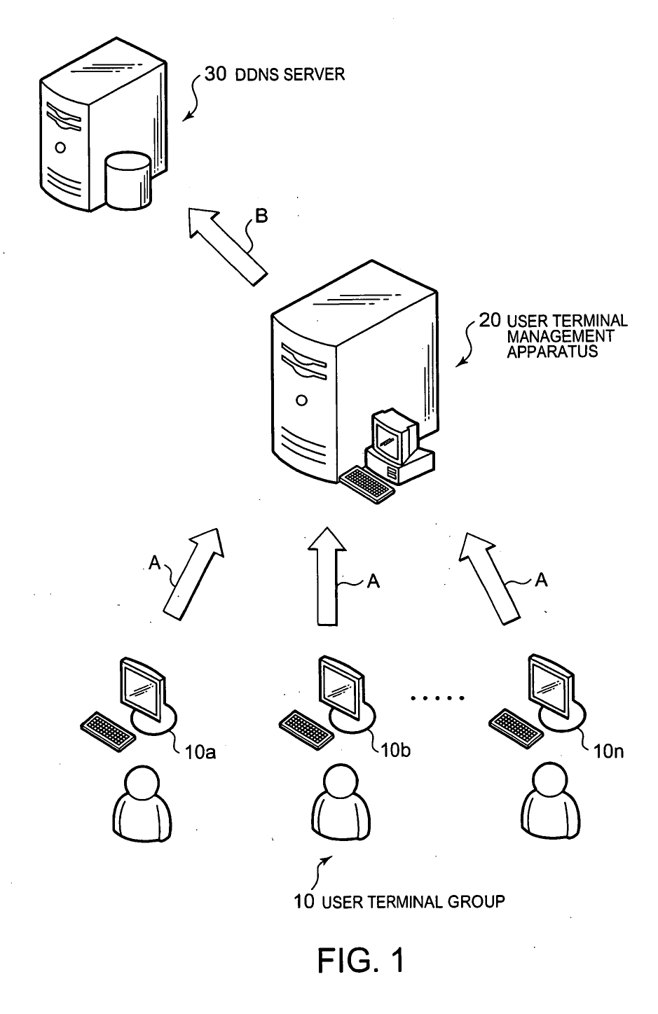

FIG. 1 shows an overview of the management of configuration data (user terminal information) configured or changed in user terminals in a user terminal management system relating to one embodiment of the present invention.

FIG. 1 shows a schematic diagram illustrating the main flow of IPv6 address information established by user terminals in user terminal management system.

User terminal management system 1 comprises terminals forming user terminal group 10 (comprised of user terminals 10a-10n), user terminal management apparatus 20, and DDNS server 30.

User terminal group 10 is information processing terminals for personal computers, etc. User terminal group 10 is composed of one or more of the user terminals 10a-10n which are network-connected.

Furthermore, user terminal information established in user terminal group 10, including various configuration data such as IPv6 address information or firewall configuration information, is transmitted to a user terminal management apparatus via the network (arrow A in FIG. 1).

User terminal management apparatus 20 is an information processing apparatus that functions as a management server for storing and performing integrated management of user terminal information of each terminal in user terminal group 10.

When the processing target information is detected in user terminal information, user terminal management apparatus 20 registers or updates the information as user terminal information managed in user terminal management apparatus 20 or transmits the prescribed information to the DNS server.

This structure enables user terminal management apparatus 20 to constantly perform integrated management of various forms of configuration data of each of the user terminals 10a-10n.

In the present embodiment, in the case that IP address information is included in the user terminal information transmitted from user terminal group 10, user terminal management apparatus 20 registers or updates the new IP address information in the table that is transmitted as user terminal information, and notifies the IP address information to the DDNS server (arrow B in FIG. 1).

DDNS server 30 is an information processing apparatus that functions as a management server for managing the correspondence table between the domain name (FQDN) and the IPv6 address of each user terminal and responds to queries from external devices or terminals.

To be specific, DDNS server 30 sends IP addresses corresponding to specified domain names (FQDNs), or reversely sends domain names (FQDNs) corresponding to specified IP addresses, in response to queries from external devices and terminals.

In the present embodiment, when information regarding changed IP addresses is received from user terminal apparatus 20, the data in relevant correspondence tables is automatically updated.

This structure allows a terminal in user terminal group 10 that is to communicate with another terminal in user terminal group 10 that the terminal desires to communicate with to obtain the IP address information currently established in the terminal by sending DDNS server 30 a query citing the domain name (FQDN) of the terminal.

Therefore, even in the case that the IP address of each of the user terminals 10a-10n is dynamically changed, the latest IP address information of the desired terminal is obtained by sending a query to the DNS server, then, a stable communications is realized constantly.

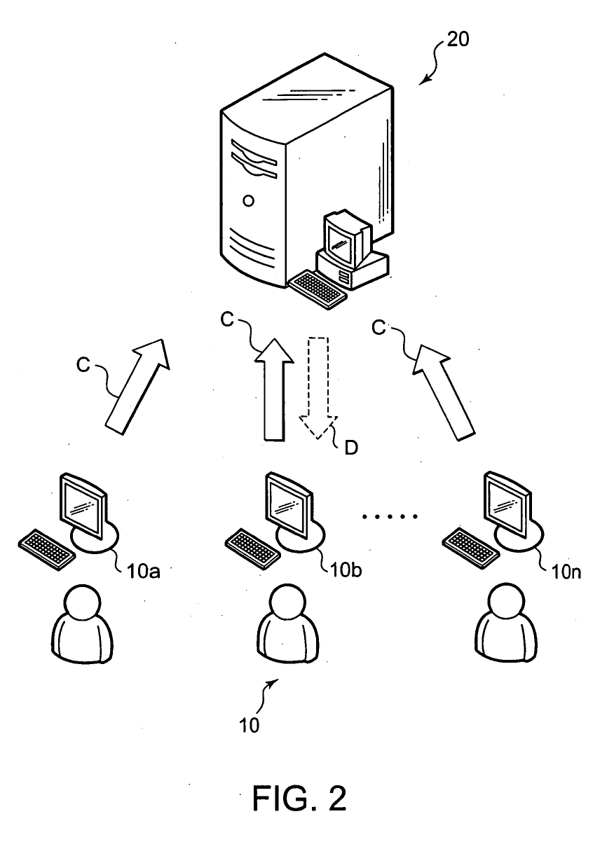

With reference to FIG. 2, an overview of the management of the firewall configuration information of user terminals in the user terminal management system relating to one embodiment of the present invention is explained.

FIG. 2 shows schematic diagram illustrating the main flow of firewall configuration information established in the user terminals of user terminal management system.

User terminal management system shown in FIG. 2 comprises user terminal group 10 and terminal management apparatus 20, described in FIG. 1.

User terminal group 10 transmits user terminal information regarding its own firewall configuration to user terminal management apparatus 20 at prescribed times (arrow C in FIG. 2).

User terminal management apparatus 20 stores the basic firewall configuration information of each of the user terminals 10a-10n and refers to it according to need.

Specifically, in the case that firewall configuration information is included in user terminal information transmitted from each of the user terminals 10a-10n, user terminal management apparatus 20 compares the configuration information with the firewall information stored in the table. Extracting any differences found, user terminal management apparatus 20 notifies the relevant terminal in user terminal group 10 and transmits the contents to user terminal group 10 (dashed arrow D in FIG. 2).

This structure allows user terminal group 10 to recognize omissions or mistakes in firewall configuration upon receiving information regarding differences from user terminal 20 and to reconfigure firewalls in an appropriate way.

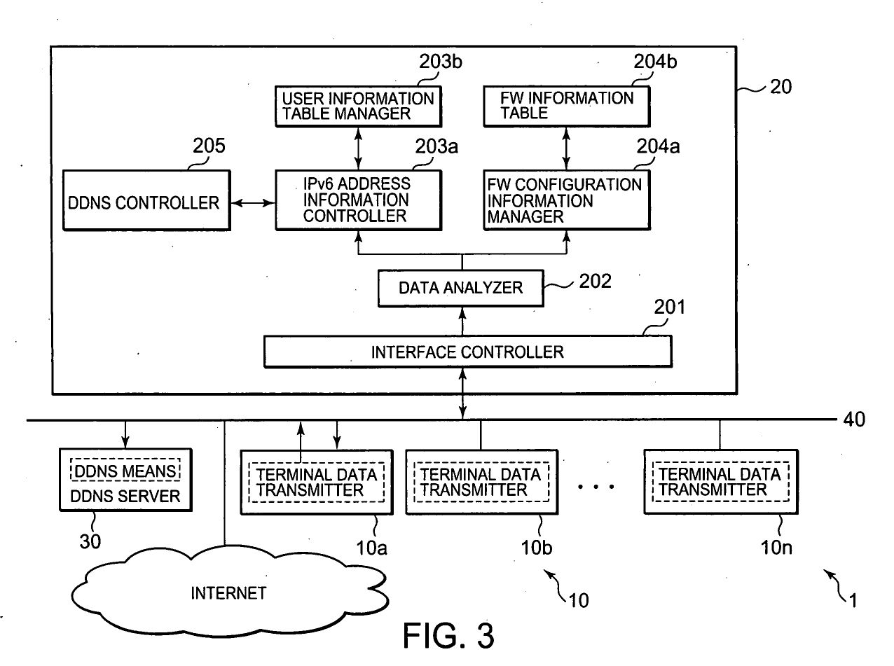

More specific structure of the user terminal management system relating to the present embodiment is shown in FIG. 3.

FIG. 3 shows a block diagram illustrating a more specific structure of the user terminal management system.

User terminals 10a-10n are information processing terminals of personal computers, etc., and are connected to user terminal management apparatus 20 via communication line 40, such as LAN.

Each of the user terminals 10a-10n comprises terminal data transmission means for transmitting user terminal information to user terminal management apparatus 20 at prescribed times. The user terminal information includes information on IP addresses and firewall configurations of itself.

At this point, IPv6 address information transmitted from user terminal group 10 to user terminal management apparatus 20 includes information such as interface information including computer IDs and IPv6 addresses. Interface information includes host names of user terminals, IPv6 addresses assigned to user terminals, and the first time and dates of use and the estimated last time and dates of use of IPv6 addresses.

User terminal management apparatus 20 is a management server for storing the user terminal information and performing integrated management of each of the user terminals 10a-10n.

As illustrated in FIG. 3, user terminal management apparatus 20 comprises interface controller 201, data analyzer 202, IPv6 address information controller 203a, user terminal information table manager 203b, FW (firewall) configuration information manager 204a, FW information table 204b, and DDNS controller 205.

Interface controller 201 is a user interface component located along communication line 40. User terminal management apparatus 20 communicates with external devices and terminals including user terminal group 10 and DDNS server 30 via interface controller 201.

Data analyzer 202 receives user terminal information (IPv6 address and FW configuration information) via interface controller 201, and analyzes the data. In the case that the received user terminal information includes IPv6 address information, the data analyzer 202 notifies IPv6 address information to controller 203a.

Furthermore, in the case that FW configuration information is included in the user terminal information, the data analyzer 202 notifies the data to FW configuration information manager 204a.

IPv6 address information controller 203a groups the computer ID, interface information, and the IPv6 address receives from data analyzer 202 and notifies user terminal information table manager 203b.

Furthermore, DDNS server 30 determines the necessity for registration of IPv6 addresses based on the data received from data analyzer 202. If IPv6 address information controller 203 determines registration in DDNS server 30 is necessary, DDNS server 30 pairs the FQDN and IPV6 addresses and notifies DDNS controller 205.

The necessity for registration in DDNS server 30 is determined based on user terminal information. To be specific, the information managed by user terminal management apparatus 20 includes “information indicating whether or not to perform registration in the DNS server” for each host name. User terminal management apparatus 20 determines whether to perform registration processing in the DNS server with reference to the information.

First reason why IPv6 address information controller 203a determines the DDNS server 30 to register IPv6 addresses is that some cases are desirable to keep user terminals private. Second reason is there are cases that the data on the DNS server is unnecessary to resister because the DNS server is used for the server for example, that is, IPv6 addresses are fixedly configured and correspondence between IPv6 and the FQDN are already made in the DNS server. Third reason is, on the other hand, it is necessary for the DDNS server 30 to open host names or domain names so as to be an open server or peer-to-peer communication terminals.

User terminal information table manager 203b manages correspondence between computer IDs, interface information, and IPv6 addresses of each of the user terminals 10a-10n. The user terminal information table manager 203b searches within the management table for corresponding records based on computer IDs and interface information, and, in the case that an corresponding record is found, the IPv6 address information is added to the table (updated).

FW configuration information manager 204a compares basic profiles managed in FW information table 204b and FW configuration information receives from data analyzer 202 and extracts difference. And then, the FW configuration information manager 204a sends the difference information to user terminal group 10, which is the source of the FW configuration information, via interface controller 201.

DDNS controller 205 creates a DNS UPDATE message for DDNS server 30 based on the information notified by IPv6 address information controller 203a, and sends the DNS UPDATE message to DDNS server 30 via interface controller 201.

DDNS server 30 comprises a table of correspondence between the domain names (FQDNs) and IPv6 addresses of each of the user terminals 10a-10n, and the DDNS server 30 is provided with a (name answer) function to respond to queries from external devices and terminals, based on the correspondence table.

The DDNS server 30 receives said DNS UPDATE messages, and updates correspondence tables on real time with respect to dynamically changing IP addresses.

Communication line 40 takes the form of LAN, so as to connect user terminal group 10, terminal management apparatus 20, and DDNS server 30 to the same network. Meanwhile, communication line 40 is connected to the internet; configuring user terminal group 10, user terminal management apparatus 20, and DDNS server 30 are individually connectable to the Internet optionally.

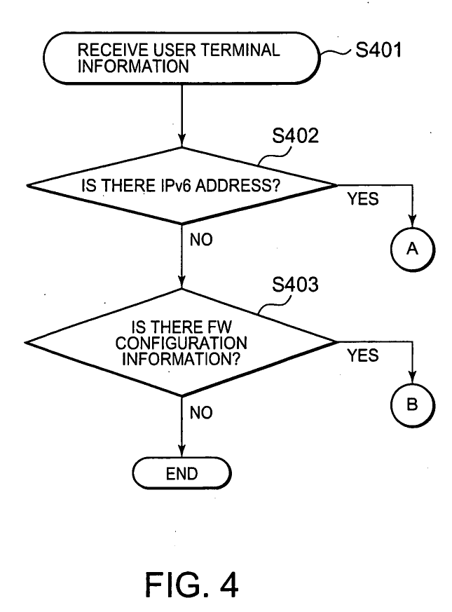

The performance of user terminal management system 1 in the present embodiment hereinafter is described in greater detail, with reference to the block diagram illustrated in FIG. 3 and the flow diagrams illustrated in FIGS. 4 to 6.

FIG. 4 illustrates the process of the invention. The user terminal management apparatus 20 receives user terminal information from one of the user terminals 10a-10n (step 401 of FIG. 4), data analyzer 202 determines whether the user terminal information includes IPv6 address information (step 402 of FIG. 2).

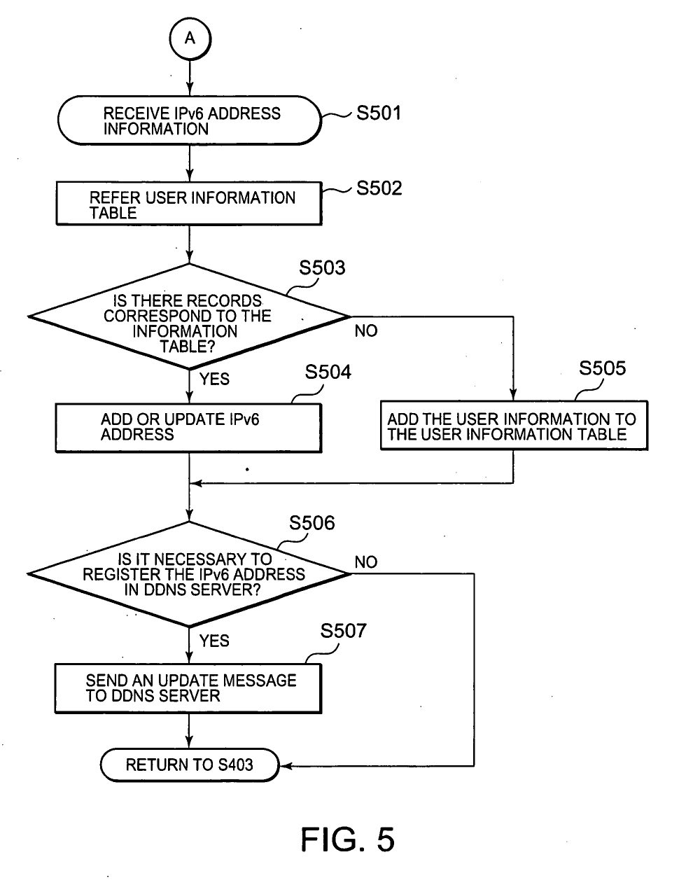

If the user terminal information includes IPv6 address information (step 402: Yes of FIG. 4), the user terminal management apparatus 20 sends notification to IPV6 address information controller 203a, subsequently moving onto the process illustrated in FIG. 5.

In the case the user terminal information does not include IPv6 information (step 402: No of FIG. 4) or the process illustrated in FIG. 5 is complete, data analyzer 202 determines whether the user terminal information includes FW configuration information (step 403 of FIG. 4).

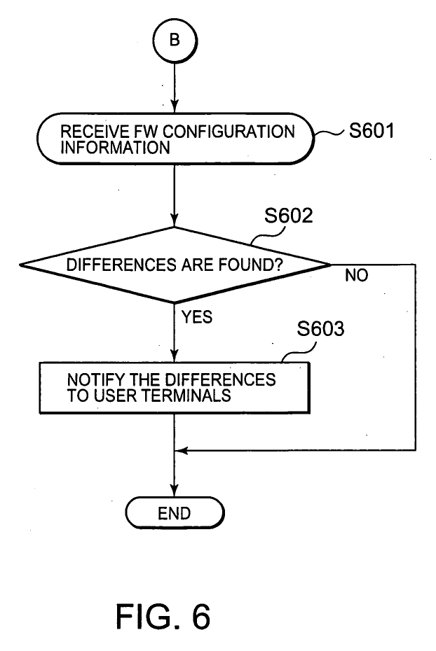

The case FW configuration information is included in user terminal information (step 403: Yes of FIG. 4), FW configuration information manager 204a receives notification from data analyzer 202, subsequently moving onto the process illustrated in FIG. 6. In the case that FW configuration information is not included in user terminal information (step 403: No of FIG. 4), the process ends.

Next, the process illustrated in FIG. 5 is explained.

In the case that IPv6 address information is included in the user terminal information that user terminal management apparatus 20 receives (step 402: Yes of FIG. 4), Notification is given to 203a IPv6 address information controller 203a.

When IPv6 address information controller 203a receives user terminal information including IPv6 address information from data analyzer 202 (step 501 of FIG. 5), the IPv6 address information controller 203a informs user information table manager 203b of the computer ID, interface information, and IPv6 address information included in the received user terminal information.

User information table manager 4 searches whether there is a corresponding record in the information table by the key which is computer ID and interface information (steps 502, 503 of FIG. 5).

In the case that an corresponding record is found as a result of the search (step 503: Yes of FIG. 5), user information table manager 4 determines the validity of the IPv6 addresses that have been already registered. According to the results, an IPv6 address is added or updated (step 504 of FIG. 5).

On the other hand, in the case that no corresponding record are found as a result of the search (step 503: No of FIG. 5), the computer ID, interface information, and IPv6 address information are made into a group and added the user information to the user information table (step 505 of FIG. 5).

Furthermore, IPv6 address information controller 203a determines the necessity for registration of the IPv6 address in DDNS server 30 based on the data received from data analyzer 202 (step 506 in FIG. 5). The IPv6 address information controller 203a pairs the FQDN with the IPV6 address of the user terminals 10a-10n and notifies DDNS controller 205 when registration in DDNS server 30 is required (step 506: Yes in FIG. 5).

DDNS controller 205 sends an UPDATE message to DDNS server 30 (step 507 in FIG. 5). By this message, the correspondence table for the IPv6 address and the FQDN in DDNS server 30 is updated.

With this, the process is complete, and returns to step 403 of FIG. 4. Additionally, in the case that no registration is required in step 506, the process is also complete.

Next, the process in FIG. 6 is described hereinafter.

In the case that the user terminal information received by user terminal management apparatus 20 does not include IPv6 information, or in the case that the process illustrated in FIG. 5 has finished, data analyzer 202 determines whether the user terminal information includes the FW configuration information (step 403 in FIG. 4). In the case that the user terminal information includes IPv6 information (step 403: Yes of FIG. 4), notification is given to FW configuration information manager 204a.

FW configuration information controller 204a has a standard security policy (basic profile) in FW information table 204b. Upon receiving user terminal information, including FW configuration information from data analyzer 202 (step 601 of FIG. 6), FW configuration information controller 204a compares the basic profile in FW information table 204b and the FW configuration information received from the user terminal, and extracts the differences if the differences are found (step 602: Yes of FIG. 6). The differences are notified to user terminal group 10 (step 603 of FIG. 6) via interface controller 201.

Thereafter, user terminal group 10 reconfigure security, etc., based on the received difference information.

With this, the process is complete. In the case that no differences exist in step 606, the process is also complete.

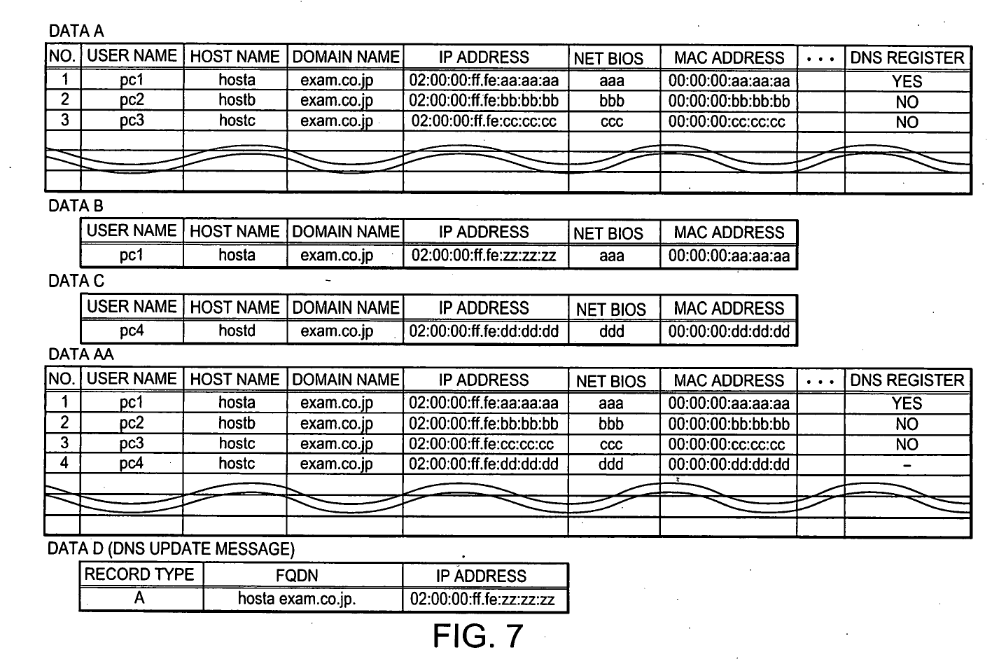

A specific example of user terminal information data managed in user terminal management system 1 is shown in FIG. 7.

It is supposed that data A shown in FIG. 7 are stored in the information table of user terminal management apparatus 20 as the user terminal information of each of the user terminals 10a-10n.

These data A are the initial data, and are registered through input operation by a user or data transmission by user terminal group 10.

In the case that one of the user terminals 10a-10n transmits the data B and user terminal management apparatus 20 receives the data B, data analyzer 202 detects whether the IP address information of user terminal group 10 is included in data B and cross-checks data A and data B.

The IP address of a terminal with user name pc1 is changed from 02:00:00:ff:fe:aa:aa:aa (data A) to 02:00:00:ff:fe:zz:zz:zz (data B); therefore, the IP address of user pc1 in data A stored in the information table is updated to 02:00:00:ff:fe:zz:zz:zz.

Furthermore, if data C are transmitted from one of the user terminals 10a-10n and user terminal management apparatus 20 receives the data C, data A and data C are cross-checked, as in the aforementioned case. Data C are user terminal information including the IP address of user pc4, and none of the data C have been registered; therefore, in this case, all of the data C are newly registered in the table as user terminal information of the terminal with user name pc4.

As a result of the above, data A, which are stored in the initial information table, are updated and added as data AA through reception of data B and data C (the updated data is shown in FIG. 7).

Further still, as shown in the “DNS registration” columns of data A and AA in FIG. 7, user terminal management apparatus 20 presets for each user terminal whether to make domain names or host names public, namely, permission in regard to external access, and user terminal management apparatus 20 registers the information in the information table. Specifically, in the data example described in FIG. 7, “yes” in the “DNS registration” columns shows that a registration is necessary, “no” shows that registration is not necessary.

Based on the above, judgments regarding whether the terminal information transmitted from the user terminal group 10 are objects for registration in DDNS server 30.

Based on this DNS registration information, DDNS controller 205 creates a DNS UPDATE message, which consists of the FQDN and IP address, as described in data D of FIG. 7.

As is shown in FIG. 7, for example, if user terminal management apparatus 20 receives data B, the IP address is detected, and since pc1 is an object for registration in DNS server 30, the DNS UPDATE message has the configuration described in data D. This UPDATE message is sent to DDNS server 30.

Meanwhile, it is shown in record “A” in the “record type” column of data D that the correspondence from the FQDN to the IP address is also stored in DDNS server 30. Other arbitrary data, such as the PTR record and the MX record, can be sent as DNS UPDATE messages.

As explained above, in accordance with the user terminal management system of the present embodiment, at times when the IPv6 address of one of the user terminal group 10 changes, user terminal group 10 notifies user terminal management apparatus 20 of the IPv6 address information. In user terminal management apparatus 20, IPv6 address information controller 203a registers the IPv6 address in user information table manager 203b, thereby enabling user terminal management apparatus 20 to perform integrated management, even in the case that a terminal in user terminal group 10 has a plurality of IPv6 addresses or IP addresses are anonymous.

Furthermore, in the present embodiment, DDNS controller 205 in user terminal management apparatus 20 transmits UPDATE messages to DDNS server 30 based on notifications from IPv6 address information controller 203a, so that the correspondence table for IPv6 addresses and the FQDNs managed by DDNS server 30 is updated.

This enables DDNS server 30 to resolve IPv6 address information, and user terminal can obtain IPv6 addresses that are currently used by the counterpart terminal by requesting that DDNS server 30 performs address resolution of the counterpart terminals, allowing for easy peer-to-peer communication among user terminals.

Further still, in the present embodiment, the basic profile of the firewall and the FW configuration information transmitted by user terminal group 10 are compared in FW configuration information manager 6 of user terminal management apparatus 20. In the case that differences are extracted, one of the user terminals 10a-10n is notifies of information regarding the differences via interface controller 201.

According to this structure, the FW configuration information of each terminal in user terminal group 10 is managed in user terminal management apparatus 20 in an integrated manner, and in the case that a security hole is found, for example, user terminal management apparatus 20 is able to immediately notify user terminal group 10, prompting the terminals in user terminal group 10 performing peer-to-peer communication with other user terminals to protect themselves.

In the above description, the user terminal management apparatus and the user terminal management system of the present invention are explained, with an example of a preferred embodiment. However, the present invention is not to be considered limited to the above embodiment, not to mention that there are many possible variations of the embodiments within the scope of the present invention.

For instance, a management server (user terminal management apparatus) registers information with which user terminals can be uniquely identified within a LAN, such as computer names (NETBIOS names).

Additionally, the DNS UPDATE in the user terminal management system in the present invention does not necessarily have to be in conformity with RFC2136.

Further still, the terminal information table or the FW information table of the user terminal management apparatus, which is a component of the present invention, can use a method to utilize and refer to an external database connected via communication line. This method enables a simple configuration of the user terminal management apparatus.

What is claimed is:

1. A user terminal management apparatus that manages user terminals, wherein the user terminal information about said user terminals is configurable or changeable, comprising:
an information table which stores said user terminal information of each of said user terminals;
a data analyzer which detects whether said user terminal information is included in said user terminal information and
a data controller which executes process including at least one of registration, updating, or transmission of said user terminal information, based on said user terminal information detected in said data controller and said user information stored in said information table.

2. A user terminal management apparatus, as claimed in claim 1, said user terminal information further includes IP address of the user terminal.

3. A user terminal management apparatus, as claimed in claim 2, wherein said data analyzer further detects whether said IP address is included in said user terminal information received from one of said user terminals, and said controller registers or updates said IP address as said user terminal information stored in said information table when said IP address is detected by said data controller.

4. A user terminal management apparatus, as claimed in claim 2, wherein said controller, when said IP address information is detected by said data controller, determines the necessity for registration of said IP address information in a DNS server and transmits said IP address information to said DNS server, according to the determination results.

5. A user terminal management apparatus, as claimed in claim 1, wherein said data analyzer detects whether firewall configuration information is included in said user terminal information received from one of said user terminals,
and when said firewall configuration information is detected by said data analyzer, said controller compares detected said firewall configuration information to said user terminal information stored in said information table and extracts the differences, and transmits said differences to said user terminals.

6. A user terminal management program which comprises a user terminal apparatus for managing one or more user terminals, wherein said user terminal information including IP address, can be arbitrarily configured or changed, to function as:
a program to store said user terminal information as information tables for each of said user terminals,
a program which receives said user terminal information to be transmitted from said user terminals,
a program which detects whether prescribed user terminal information is included in said received user terminal information and
a program which executes prescribed process including at least one of registration, updating, or transmission of said user terminal information, based on said user terminal information detected and said user information stored as an information table.

7. A user terminal management system comprising one or more user terminals wherein prescribed user terminal information is arbitrarily configurable or changeable, comprising:
a user terminal management apparatus for managing said user terminal information of said user terminals,
wherein said user terminals comprise the means for transmitting updated user terminal information to said terminal management apparatus in the case that said user terminal information configured in the relevant user terminal is changed and said user terminal management apparatus comprising:
an information table for storing said user terminal information of each of said user terminals,
an interface controller for receiving said user terminal information transmitted from said user terminals,
a data analyzer for detecting whether prescribed user information is included in said user terminal information received through said interface controller and
a controller for executing prescribed process including at least one of registration, updating, or transmission of said user terminal information, based on said user terminal information detected in said data analyzer and said user terminal information stored in said information table.
